(19) United States
(12) Patent Application Publication
(10) Pub. No.: US 2015/0329702 A1
(43) Pub. Date: Nov. 19, 2015

(54) WARM MIX RECYCLED ASPHALT ADDITIVE CONTAINING OIL DREGS, AND WARM MIX RECYCLED ASPHALT MIXTURE CONTAINING SAME

(71) Applicants: KOREA INSTITUTE OF CONSTRUCTION TECHNOLOGY, Goyang-si, Gyeonggi-do (KR); KOREA KUMHO PETROCHEMICAL CO., LTD., Seoul (KR)

(72) Inventors: Sung Do HWANG, Gyeonggi-do (KR); Dong Woo CHO, Seoul (KR); Soo Ahn KWON, Gyeonggi-do (KR); Kyu Dong JEONG, Incheon (KR); Yong Joo KIM, Seoul (KR); Cheolmin BAEK, Gyeonggi-do (KR); Yeong Min KIM, Gyeonggi-do (KR); Moon Sup LEE, Gyeonggi-do (KR); Sung Lin YANG, Gyeonggi-do (KR); Jin Wook LEE, Gyeonggi-do (KR); Junsang PARK, Daejeon (KR); Joonbum PYUN, Daejeon (KR); Hansoo PARK, Daejeon (KR); Hyeok-Jung KIM, Chungcheongnam-do (KR)

(21) Appl. No.: 14/651,574

(22) PCT Filed: Dec. 9, 2013
(86) PCT No.: PCT/KR2013/011369

§ 371 Date: Jun. 11, 2015

(30) Foreign Application Priority Data
Dec. 11, 2012 (KR) 10-2012-0143814

(51) Int. Cl. C08K 5/09

(52) U.S. Cl. CPC C08K 5/09

(57) ABSTRACT

A warm mix recycled asphalt additive according to one embodiment includes dregs of oil and fat which are the by-products remaining after fatty acids are extracted from oils. In addition, the warm mix asphalt mixture according to another embodiment includes 2-15 wt % of the warm mix recycled asphalt additive, having dregs of oil and fat which are the by-products remaining after fatty acids are extracted from oils, on the basis of the total amount of waste asphalt in waste asphalt concrete. It is possible to overcome the problem of brittleness or the deterioration of lower temperature properties even if mixing and using waste asphalt concrete and new asphalt concrete when making asphalt concrete, to minimize the generation of toxic gas by exhibiting a technique for paving a warm mix mixture, and to reduce the environmental burden by efficiently regenerating waste asphalt concrete and recycling organic dregs.

### TECHNICAL FIELD

Exemplary embodiments of the present invention relate to a warm mix recycled asphalt additive including dregs of oil and fat, which may exhibit a technique for warm mixing and recycling pavement with respect to waste asphalt concrete, and a warm mix recycled asphalt mixture including the same.

### BACKGROUND ART

An asphalt mixture is commonly called ascon. It is prepared by feeding asphalt, aggregate and mineral fillers into an asphalt mixing plant and heating the mixture at temperature of 160 to 180° C. and then cooled to room temperature in paving and compacting process.

Accordingly, high energy is required for the high-temperature heating and harmful gases such as carbon dioxide, sulfates or nitrogen oxide are increasingly discharged during preparation and pavement of the asphalt mixture. Moreover, since a lot of time is required in order to cool the heated asphalt mixture to room temperature in pavement of roads, thus traffic opening time is delayed and workers are exposed to the risk of safety accidents.

Recently, in order to overcome these drawbacks, research into a warm mix recycled asphalt mixture (WMA) is actively performed. In WMA, an asphalt mixture is mixed and compacted at temperature which is 20 to 40° C. lower than a hot-mix asphalt mixture (HMA). Further, it is required to develop a warm mix additive for the warm mix recycled asphalt mixture with enhanced performances.

Core mechanism for WMA pavement technology is to improve flowability of asphalt. More specifically, in warm mix pavement technology, optimal viscosity and thus optimal. compaction rate are exhibited at temperature lower than those of HMA, respectively, by using an additive.

Meanwhile, as time passes after pavement, cracks and deformation occur in asphalt roads due to aging of asphalt binders by repeated vehicle traffic and ambient environment. In case of the road where cracks and deformation occur due to long-term use and aging, waste asphalt concrete is removed and then new ascon is paved. Since such waste asphalt concrete causes water pollution by contaminating ground water and river if it is scrapped by burying without special treatment, it is classified as industrial wastes. Therefore, researches are actively performed in order to minimize and recycle the waste asphalt concrete.

In general, the waste asphalt concrete is recycled to be used as cyclic aggregate. Usually, the waste asphalt concrete is pulverized, mixed with new aggregate and new asphalt, and then reused for paving roads. In this case, viscosity of aged asphalt contained in the waste asphalt concrete is high and asphaltene content is increased due to aging so that compaction is not properly performed. Moreover, although compaction is performed, performance at the beginning of pavement may be satisfying but crack and damage occur due to weak brittleness during use.

A recycled additive is generally used in order to overcome these drawbacks. The recycled additive is developed such that components of aged asphalt are improved and have properties similar to those of new asphalt.

That is, asphalt is composed of asphaltene, resin, oil, and so on. Component contents are varied depending on kinds of asphalt, for example, in case of asphalt with a penetration grade of 100, the asphalt includes 13-29% of asphaltene, 2.3-4.5% of resin, 44-58%9 of oil, and so on. As the asphalt ages, components such as resin or oil are changed into asphaltene and thus asphaltene contents are increased. The recycled additive focuses on having asphaltene content of aged asphalt similar to that of new asphalt by adding supplements.

However, since such recycled additive is aimed at simple improvement on components of asphalt, ascon using the recycled additive is prepared at temperature similar to, or 5 to lot higher than common ascon in order to ensure sufficient mixing. Therefore, when preparing asphalt mixtures, the above mentioned problems still remain, that is, high energy is required in order to heat the asphalt mixtures at high temperature and harmful gases such as carbon dioxide are increasingly discharged. Moreover, since aging degree of the waste asphalt concrete is varied in each case, there is a limit to recycling the asphalt contained in various waste asphalt concrete with a single recycled additive.

Asphaltene is a highly concentrated aromatic compound having polar functional groups with a lot of heteroatom so that it is expected to have a structure where the polar functional groups strongly bond together. It is reported that polarity of asphaltene is caused by heteroatoms such as S, N or O. Asphaltene without flowability is increased due to aging of the asphalt so that brittleness and low-temperature properties of the asphalt in the waste asphalt concrete are deteriorated. Accordingly, it is required to develop a recycled additive capable of not simply improving components of aged asphalt but rapidly improving flexibility of asphaltene.

As a consequence, it required to develop an additive which does not deteriorate brittleness and can exhibit warm mix pavement technology even if the waste asphalt concrete is mixed with new ascon when preparing ascon.

Meanwhile, animal and vegetable oil and fat such as beef tallow, palm oils or coconut oils are subject to hydrolysis or saponification to result in fatty acids such as stearic acids, lauric acids, palmitic acids, myristic acids, oleic acids, linoleic acids, linolenic acids or ricinoleic acids. After extracting fatty acids from oil and fat, dregs of oil and fat with high viscosity and black color are remained. Such dregs of oil and fat are valueless to be buried or incinerated as wastes. Accordingly, it is required to develop a method for industrially using such dregs of oil and fat, which have been scrapped.

### DISCLOSURE

### Technical Problem

It is an object of exemplary embodiments of the present invention to provide a warm mix recycled asphalt additive including dregs of oil and fat, which may overcome a problem of decreasing brittleness and low-temperature properties even if waste asphalt concretes are mixed with new ascon when preparing ascon, exhibit warm mix pavement technology, minimize the generation of harmful gases, efficiently recycle waste asphalt concretes, recycle dregs of oil and fat which have been treated as wastes and reduce an environmental burden, a method for preparing the same, a warm mix recycled asphalt mixture including the same, and a method for preparing a warm mix recycled asphalt mixture.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an embodiment of the present invention, a warm mix recycled asphalt additive includes dregs of oil and fat which are by-products remaining after extraction of fatty acids from the oil and fat.

In accordance with another embodiment of the present invention, a method for preparing a warm mix recycled asphalt additive includes extracting fatty acids from oil and fat; and obtaining dregs of oil and fat which are by-products remaining after extraction.

In accordance with still another embodiment of the present invention, a warm mix recycled asphalt mixture includes 2 to 15 wt % of a warm mix recycled asphalt additive including dregs of oil and fat which are by-products remaining after extraction of fatty acids from the oil and fat, based on the total amount of waste asphalt contained in waste asphalt concrete.

In accordance with still yet another embodiment of the present invention, a method for preparing a warm mix recycled asphalt mixture includes preparing a warm mix recycled asphalt additive including dregs of oil and fat which are by-products remaining after extraction of fatty acids from the oil and fat; and melt-mixing the warm mix recycled additive with cyclic aggregate including waste asphalt concrete, wherein the preparing of the warm mix recycled asphalt additive includes extracting fatty acids from oil and fat; and obtaining dregs of oil and fat which are by-products remaining after extraction, and wherein the warm mix recycled additive is included in an amount of 2 to 15 wt % based on the total amount of waste asphalt contained in the waste asphalt concrete.

### Advantageous Effects

In accordance with exemplary embodiments of the present invention, using dregs of oil and fat allows for increasing miscibility with asphalt and improving low-temperature properties and flexibility of asphaltene to exhibit recycling effect and warm mixing effect with respect to waste asphalt concrete.

Accordingly, by using a warm mix recycled asphalt additive including dregs of oil and fat according to exemplary embodiments of the present invention, even if waste asphalt concrete is mixed with new ascon when preparing ascon, problems such as deterioration of brittleness or low-temperature properties can be overcome.

Moreover, it is possible to decrease temperature of preparation and compaction for asphalt concrete without deterioration of physical properties. Therefore, the generation of harmful gases such as carbon dioxide, sulfates or nitrogen oxide can be minimized and waste asphalt concrete can be efficiently recycled to show advantageous effects in view of environment.

Further, dregs of oil and fat which have been treated as wastes can be used as industrially useful materials and preferred effects on resources recycling and environment can be achieved.

### BEST MODE FOR THE INVENTION

The advantages, features and aspects of the invention will become apparent from the following description of the embodiments, which is set forth hereinafter.

A warm mix recycled asphalt additive in accordance with an embodiment of the present invention includes dregs of oil and fat which are by-products remaining after extraction of fatty acids from the oil and fat.

The dregs of oil and fat included in the warm mix recycled asphalt additive in accordance with an embodiment of present are by-products remaining after extraction of fatty acids from the oil and fat for example, by hydrolysis, saponification, and so on. The fatty acids which may be extracted from the oil and fat may be one or more selected from the group consisting of stearic acids, lauric acids, palmitic acids, myristic acids, oleic acids, linoleic acids, linolenic acids and ricinoleic acids.

The dregs of oil and fat have high viscosity and black color. They are in liquid- or solid-phase at room temperature and in liquid-phase at temperature of 60° C. or more.

Such dregs of oil and fat may exhibit recycling effects and warm mixing effects on waste asphalt concrete and improve low-temperature properties of the asphalt concrete.

The oil and fat may be one or more selected from the group consisting of vegetable oil and fat, animal oil and fat, and synthetic oil and fat.

Examples of the oil and fat may include one or more selected from beef tallow, palm oils and coconut oils.

Moreover, the dregs of oil and fat are components remaining after obtaining fatty acids or palm wax components by hydrolysis or saponification of the oil and fat such as beef tallow, palm oils, or coconut oil and the specific kinds thereof are not limited. In particular, the dregs of oil and fat having 140° C. viscosity of 80 cps or less is preferred. In case of the dregs of oil and fat having 140° C. viscosity more than 80 cps, viscosity may be excessively high to reduce warm mixing effects.

The warm mix recycled asphalt additive in accordance with an embodiment of the present invention may include one or more viscosity reducing agent selected from the group consisting of surfactants, aromatic oils, paraffin oils, vegetable oils and animal oils.

The viscosity reducing agent may reinforce the warm mixing function of the additive, prevent decreasing low-temperature properties of the asphalt, be mixed with the dregs of oil and fat to obtain flowability at room temperature, and increase dispersion rate of the additive.

The viscosity reducing agent is preferably included in an amount of 10 to 100 parts by weight with respect to 100 parts by weight of the dregs of oil and fat. In case that the amount of the viscosity reducing agent is less than 10 parts by weight, improvement effects on low-temperature properties and viscosity of the asphalt are insignificant. On the other hand, in case that the amount of the viscosity reducing agent is more than 100 parts by weight, high-temperature properties of the asphalt is decreased.

Preferably, the viscosity reducing agent has viscosity at temperature of 100° C. of 50 cps or less and more preferably, the viscosity reducing agent has viscosity at temperature of 25° C. of 300 cps or less. In case that viscosity at temperature of 100° C. is more than 50 cps or viscosity at temperature of 25° C. is more than 300 cps, effects of securing flowability and warm mixing are reduced.

The warm mix recycled asphalt additive in accordance with an embodiment of the present invention may include one or more selected from the group consisting of an antioxidant, a thermal stabilizer, an antistatic agent and a lubricant.

A method for preparing a warm mix recycled asphalt additive in accordance with another embodiment of the present invention includes extracting fatty acids from oil and fat; and obtaining dregs of oil and fat which are by-products remaining after extraction.

Here, the dregs of oil and fat are by-products remaining after extraction of fatty acids from the oil and fat, have high viscosity and black color, and are in liquid- or solid-phase at room temperature and in liquid-phase at temperature of 60° C. or more. The fatty acids which may be extracted from the oil and fat may be one or more selected from the group consisting of stearic acids, lauric acids, palmitic acids, myristic acids, oleic acids, linoleic acids, linolenic acids and ricinoleic acids. Since the detailed description of the dregs of oil and fat is similar to that presented above with respect to the previous embodiment, it is omitted here.

The extracting fatty acids from the oil and fat may be performed through hydrolysis or saponification, but is not limited thereto.

The method for preparing a warm mix recycled asphalt additive in accordance with another embodiment of the present invention may include mixing the dregs of oil and fat with one or more viscosity reducing agent selected from the group consisting of surfactants, aromatic oils, paraffin oils, vegetable oils and animal oils.

The viscosity reducing agent is preferably included in amount of 10 to 100 parts by weight with respect to 100 parts by weight of the dregs of oil and fat.

Since the detailed description of the viscosity reducing agent is similar to that presented above with respect to the previous embodiment, it is omitted here.

In one embodiment, the method may further include mixing the obtained dregs of oil and fat with one or more selected from the group consisting of an antioxidant, a thermal stabilizer, an antistatic agent and a lubricant.

A warm mix recycled asphalt mixture in accordance with still another embodiment of the present invention includes 2 to 15 wt % of a warm mix recycled asphalt additive including dregs of oil and fat which are by-products remaining after extraction of fatty acids from the oil and fat, based on the total amount of waste asphalt contained in waste asphalt concrete.

The warm mix recycled asphalt mixture includes 2 to 15 wt % of the warm mix recycled asphalt additive based on the total amount of waste asphalt contained in waste asphalt concrete so as to exhibit recycling and warm mixing effects of the waste asphalt concrete and obtain the recycled asphalt concrete with superior low-temperature properties.

In case that the amount of the warm mix recycled additive is less than 2 wt %, restoring effects on waste asphalt is not significant. On the other hand, in case that the amount of the warm mix recycled additive is more than 15 wt %, a softening point is decreased to be problematic as asphalt and improvement effects are not significant in view of increasing the amount of the additive.

Since the detailed description of the warm mix recycled asphalt additive including dregs of oil and fat is similar to that presented above with respect to the previous embodiment, it is omitted here.

The warm mix recycled asphalt mixture in accordance with another embodiment of the present invention may include cyclic aggregate including waste asphalt concrete.

In one embodiment, the cyclic aggregate including the waste asphalt concrete may be included in an amount of 15 to 100 wt % based on the total amount of the asphalt mixture.

Moreover, the warm mix recycled asphalt mixture may further include new aggregate, new asphalt, or a mixture thereof in addition to the cyclic aggregate including the waste asphalt concrete.

In one embodiment, the new aggregate and the new asphalt may be included in an amount of 0 to 85 wt % and 0 to 5 wt %, respectively, based on the total amount of the recycled asphalt mixture.

The cyclic aggregate may be obtained by pulverizing the waste asphalt concrete into powder with a given size.

A method for preparing a warm mix recycled asphalt mixture includes preparing a warm mix recycled asphalt additive including dregs of oil and fat which are by-products remaining after extraction of fatty acids from the oil and fat; melt-mixing the warm mix recycled additive with cyclic aggregate including waste asphalt concrete, wherein the preparing of the warm mix recycled asphalt additive includes extracting fatty acids from the oil and fat; and obtaining dregs of oil and fat which are by-products remaining after extraction, and wherein the warm mix recycled additive is included in an amount of 2 to 15 wt % based on the total amount of waste asphalt contained in the waste asphalt concrete.

In one embodiment, the cyclic aggregate including waste asphalt concrete may be included in an amount of 15 to 100 wt % based on the total amount of the asphalt mixture.

In addition, the method for the warm mix recycled asphalt mixture in accordance with an embodiment of the present invention may further include melt-mixing the warm mix recycled additive with new aggregate, new asphalt, or a mixture thereof in addition to the cyclic aggregate including the waste asphalt concrete.

In one embodiment, the new aggregate and the new asphalt may be included in an amount of 0 to 85 wt % and 0 to 5 wt %, respectively, based on the total amount of the recycled asphalt mixture.

The cyclic aggregate may be obtained by pulverizing the waste asphalt concrete down to a given size.

Since the detailed descriptions of the warm mix recycled asphalt additive including the dregs of oil and fat, the method for preparing the same and the warm mix recycled asphalt including the same are similar to those presented above with respect to the previous embodiment, they are omitted here.

Now, the present invention will be described in more detail with reference to the following examples. These examples are provided only for illustration of the present invention and should not be construed as limiting the scope and spirit of the present invention.

### Examples

### 1. Experimental Materials

(1) New asphalt AP5: Asphalt having a penetration degree of 70 (PG 64-22) as asphalt having a penetration grade of 60 to 80. AP5 was used as new asphalt to be mixed with waste asphalt for evaluation of properties.

(2) New asphalt AP3: Asphalt having a penetration degree of 90 (PG 58-22) as asphalt having a penetration grade of 80 to 100. AP3 was used as new asphalt to be mixed with waste asphalt for evaluation of properties.

(3) Waste asphalt (Old AP): Asphalt extracted from waste asphalt concrete using Standard Practice for “Recovery of Asphalt from Solution Using the Rotary Evaporator” according to KS F 2396 (penetration grade: 21, PG 82-12).

(4) Recycled additive: ACF1000 commercially available from Interchimica, Italy.

(5) Dregs of oil and fat: Dregs of oil and fat remaining after extraction of fatty acids from palm oils.

(6) Viscosity reducing agent: Soybean oils having 25° C. viscosity of 50 cps.

(7) Stearic acids: Fatty acids from the oil and fat.

(8) New aggregate: 19 mm aggregate, 13 mm aggregate and fine aggregate were used as the new aggregate and each weight percentage of a sample passing through a sieve are shown in Table 1.

TABLE 1

| | Weight percentage of a sample passing through a sieve (%) | | | | | | | | | |
|---|---|---|---|---|---|---|---|---|---|---|
| | | | | | 5 mm | 2.5 mm | 0.6 mm | 0.3 mm | 0.15 mm | 0.08 mm |
| | 25 mm | 20 mm | 13 mm | 10 mm | (#4) | (#8) | (#30) | (#50) | (#100) | (#200) |
| 19 mm | 100 | 99.7 | 44.6 | 2.2 | 0.1 | 0.1 | 0.1 | 0.1 | 0.1 | 0.1 |
| aggregate | | | | | | | | | | |
| 13 mm | 100 | 100 | 100 | 78.4 | 5.9 | 0.7 | 0.4 | 0.4 | 0.4 | 0.4 |
| aggregate | | | | | | | | | | |
| Fine | 100 | 100 | 100 | 100 | 96.1 | 62.8 | 25.9 | 18 | 9.3 | 3 |
| aggregate | | | | | | | | | | |

(9) Cyclic aggregate (waste ascon): Cyclic aggregate having 5 wt % of asphalt (waste asphalt) was used and the weight percentage of a sample passing through a sieve is shown in Table 2.

TABLE 2

| | Weight percentage of a sample passing through a sieve (%) | | | | | | | | | |
|---|---|---|---|---|---|---|---|---|---|---|
| | | | | | 5 mm | 2.5 mm | 0.6 mm | 0.3 mm | 0.15 mm | 0.08 mm |
| | 25 mm | 20 mm | 13 mm | 10 mm | (#4) | (#8) | (#30) | (#50) | (#100) | (#200) |
| Cyclic | 100 | 100 | 98.8 | 88.9 | 64.6 | 48.9 | 26.7 | 19 | 12.2 | 6.9 |
| aggregate | | | | | | | | | | |

(10) Aggregate gradation: A mixing ratio and weight percentage of a sample passing through a sieve with respect to aggregate gradation are shown in Tables 3 and 4, respectively. The aggregate gradation fulfills WC-3 standards.

TABLE 3

| | cyclic | | | fine | |
|---|---|---|---|---|---|
| | aggregate | 19 mm | 13 mm | aggregate | filler |
| Mixing | 50 | 36 | 2 | 8 | 4 |
| ratio (%) | | | | | |

TABLE 4

| | | | | | | 5 mm | 2.5 mm | 0.6 mm | 0.3 mm | 0.15 mm | 0.08 mm |
|---|---|---|---|---|---|---|---|---|---|---|---|
| | | 25 mm | 20 mm | 13 mm | 10 mm | (#4) | (#8) | (#30) | (#50) | (#100) | (#200) |
| WC-3 | Min | 100.0 | 90.0 | 72.0 | 56.0 | 35.0 | 23.0 | 10.0 | 5.0 | 3.0 | 2.0 |
| standards | Max | 100.0 | 100.0 | 90.0 | 80.0 | 65.0 | 49.0 | 28.0 | 19.0 | 13.0 | 8.0 |

| | | | | | | | | | | |
|---|---|---|---|---|---|---|---|---|---|---|
| gradation | 100.0 | 99.9 | 79.2 | 56.2 | 38.1 | 26.9 | 15.3 | 11.3 | 7.4 | 3.4 |

### 2. Experimental Method

(1) Evaluation of Binder Properties

1) New asphalt having a penetration grade of 70 was mixed with waste asphalt extracted from waste asphalt concrete in a ratio of 50:50 to form asphalt. Then, additives were added to the asphalt according to Examples and Comparative Examples and binder's properties were evaluated (See, Tables 5 and 6).

2) A penetration grade was measured at temperature of 25° C. according to KS M 2252. A softening point was measured according to KS M 2250.

3) In order to evaluate low-temperature properties of the asphalt, the asphalt was subject to PAV (Pressure Aging Vessel), followed by measurement of −12° C. m-value by BBR (Bending Beam Rheometer).

4) In order to evaluate crack resistance of the asphalt, 15° C. ductility was measured according to KS M 2254.

5) Viscosity of the asphalt was measured by a rotational viscometer at temperature of 1401.

(2) Preparation of Asphalt Mixtures and Evaluation of Compaction Performance

1) 50 parts by weight of cyclic aggregate (waste ascon), 47.5 parts by weight of new aggregate and 2.5 parts by weight of new asphalt were heated to 130° C. and warm mix recycled asphalt additives and hot mix recycled asphalt additives prepared according to Examples and Comparative Examples were added, respectively to prepare warm mix recycled asphalt mixtures and hot mix recycled asphalt mixtures, respectively. In order to evaluate compaction performance of the prepared asphalt mixtures, porosity, moisture resistance and indirect tensile strength were tested (See, Table 7).

2) According to KS F 2398, a tensile strength ratio (TSR) representing moisture resistance of the asphalt mixtures was measured by measuring indirect tensile strength both in a dry state and a water saturation state.

3) According to KS F 2382, indirect tensile strength of the asphalt mixtures was measured in case of loading at 50 mm/min.

### 3. Experimental Results

(1) Binder Properties of the Asphalt

Binder properties of the asphalt prepared as above were measured according to the above method and results are shown in Tables 5 and 6.

TABLE 5

| | | Example | Example | Example | Example | Example | Example |
|---|---|---|---|---|---|---|---|
| | | 1 | 2 | 3 | 4 | 5 | 6 |
| Asphalt | AP5 | 50 | 50 | 50 | 50 | 50 | 50 |
| (phr) | Old AP | 50 | 50 | 50 | 50 | 50 | 50 |

| | | | | | | |
|---|---|---|---|---|---|---|
| Dregs of oil and | 2 | 4 | 6 | 2 | 4 | 4 |
| fat (phr) | | | | | | |
| Viscosity | — | — | — | 1 | 1 | 2 |
| reducing | | | | | | |
| agent (phr) | | | | | | |
| Penetration | 58 | 69 | 74 | 56 | 64 | 59 |
| grade (25° C., mm) | | | | | | |
| Softening | 52 | 50 | 49 | 54 | 32 | 56 |
| point (° C.) | | | | | | |
| Viscosity | 400 | 360 | 352 | 370 | 332 | 290 |
| (140° C., cps) | | | | | | |
| Ductility | 140 cm | 140 cm | 140 cm | 140 cm | 140 cm | 140 cm |
| (15° C., cm) | or more | or more | or more | or more | or more | or more |
| m-value (−12° C.) | 0.31 | 0.34 | 0.36 | 0.30 | 0.35 | 0.36 |

TABLE 6

| | | Comp. | Comp. | Comp. | Comp. | Comp. | Comp. | Comp. |
|---|---|---|---|---|---|---|---|---|
| | | Examp. 1 | Examp. 2 | Examp. 3 | Examp. 4 | Examp. 5 | Examp. 6 | Examp. 7 |
| Asphalt | AP5 | 100 | 50 | 50 | 50 | 50 | 50 | 50 |
| (phr) | Old | 0 | 50 | 50 | 50 | 50 | 50 | 50 |
| | AP | | | | | | | |

| | | | | | | | |
|---|---|---|---|---|---|---|---|
| Dregs of oil | — | — | 10 | — | — | — | — |
| and fat (phr) | | | | | | | |
| Viscosity | — | — | — | 2 | — | — | — |
| reducing | | | | | | | |
| agent (phr) | | | | | | | |
| Stearic | — | — | — | — | 10 | — | — |
| acids (phr) | | | | | | | |
| Recycled | — | — | — | — | — | 2 | 6 |
| additive (phr) | | | | | | | |
| Penetration | 56 | 41 | 88 | 43 | 70 | 56 | 67 |
| grade (25° C., | | | | | | | |
| mm) | | | | | | | |
| Softening | 50 | 57 | 43 | 37 | 54 | 51 | 50 |
| point (° C.) | | | | | | | |
| Viscosity | 405 | 580 | 320 | 410 | 300 | 418 | 380 |
| (140° C., cps) | | | | | | | |
| Ductility | 140 cm | 6 | 140 cm | 30 | 20 | 100 | 140 cm |
| (15° C., cm) | or more | | or more | | | | or more |
| m-value | 0.33 | — | 0.38 | — | 0.31 | 0.31 | 0.35 |
| (−12° C.) | | | | | | | |

In case of Comparative Examples 2 and 4, m-value could not be measured because samples were broken during the measurement due to brittleness.

In view of the experimental results shown in Tables 5 and 6, it can be confirmed that recycling and warm mixing effects on the waste asphalt concrete are exhibited by using the warm mix recycled additive according to the present invention. In comparison of Example 1 with Comparative Example 6 in terms of ductility and viscosity, the additive of the present invention has recycling and warm mixing effects superior to those of the commercially available recycled additive. From Comparative Example 3, it is found that using excessive warm mix recycled additive causes softening asphalt binder to rapidly decrease the softening point. In view of m-value in BBR test, it is shown that the warm mix recycled additive according to the present invention improves low-temperature properties (See, Examples 1 and 3, and Comparative Examples 6 and 7). Moreover, in case of using fatty acids instead of the dregs of oil and fat, it is found that recycling effects are not exhibited in view of Comparative Example 5.

(2) Compaction Performance of the Asphalt Mixture

Compaction performance of the asphalt mixtures prepared as above was evaluated and the results are shown in Table 7.

TABLE 7

| | | | | | Comp. | Comp. |
|---|---|---|---|---|---|---|
| | | Example | Example | Example | Examp. | Examp. |
| | | 7 | 8 | 9 | 8 | 9 |
| Asphalt | New asphalt | 2.5 | 2.5 | 2.5 | 2.5 | 2.5 |
| mixture | New aggregate | 47.5 | 47.5 | 47.5 | 47.5 | 47.5 |
| (phr) | Cycic | 50 | 50 | 50 | 50 | 50 |
| | aggregate (old | | | | | |
| | asphalt + old | | | | | |
| | aggregate) | | | | | |

| | | | | | |
|---|---|---|---|---|---|
| Dregs of oil and fat | 0.004 | 0.005 | 0.012 | — | — |
| (phr) | | | | | |
| Viscosity reducing | — | — | 0.004 | — | — |
| agent (phr) | | | | | |
| Recycled additive | — | — | — | 0.004 | 0.005 |
| (phr) | | | | | |
| Preparation | 130° C. | 130° C. | 130° C. | 160° C. | 160° C. |
| temperature (° C.) | | | | | |
| Porosity (%) | 3.9 | 4.0 | 4.4 | 4.0 | 4.3 |
| Moisture resistance | 75.9 | 76.3 | 73.8 | 75.4 | 74.0 |
| (TSR, %) | | | | | |
| Indirect tensile | 1.11 | 1.23 | 1.06 | 1.10 | 0.98 |
| strength (MPa) | | | | | |

As shown in Table 7, the warm mix recycled asphalt mixtures prepared by using the warm mix recycled additive according to the present invention satisfied moisture resistance standards (i.e., 75% or more) within a range of 2 to 4%. In view of the results for moisture resistance and indirect tensile strength, the warm mix recycled asphalt mixtures prepared by using the warm mix recycled additive according to the present invention exhibited more significant performance than that of the hot mix recycled asphalt mixtures prepared by using the commercially available recycled additive (See, Examples 7 and 8, and Comparative Examples 8 and 9). From Example 9, it is found that using excessive warm mix recycled additive results in decreasing strength and moisture resistance of the asphalt mixture.

The present application contains subject matter related to Korean Patent Application No. 10-2012-0143814, filed in the Korean Intellectual Property Office on Dec. 11, 2012, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A warm mix recycled asphalt additive comprising dregs of oil and fat which are by-products remaining after extraction of fatty acids from the oil and fat.

2. The warm mix recycled asphalt additive according to claim 1, wherein the oil and fat are one or more selected from the group consisting of vegetable oil and fat, animal oil and fat, and synthetic oil and fat.

3. The warm mix recycled asphalt additive according to claim 1, wherein the fatty acids are one or more selected from the group consisting of stearic acids, lauric acids, palmitic acids, myristic acids, oleic acids, linoleic acids, linolenic acids and ricinoleic acids.

4. The warm mix recycled asphalt additive according to claim 1, wherein the dregs of oil and fat have viscosity at temperature of 140 of 80 cps or less.

5. The warm mix recycled asphalt additive according to claim 1, further comprising one or more viscosity reducing agent selected from the group consisting of surfactants, aromatic oils, paraffin oils, vegetable oils and animal oils.

6. The warm mix recycled asphalt additive according to claim 5, wherein the viscosity reducing agent is comprised in an amount of 10˜100 parts by weight with respect to 100 parts of the dregs of oil and fat.

7. A method for preparing a warm mix recycled asphalt additive comprising:
extracting fatty acids from oil and fat; and
obtaining dregs of oil and fat which are by-products remaining after extraction.

8. The method for preparing a warm mix recycled asphalt additive according to claim 7, further comprising mixing the obtained dregs of oil and fat with one or more viscosity reducing agent selected from the group consisting of surfactants, aromatic oils, paraffin oils, vegetable oils and animal oils.

9. The method for preparing a warm mix recycled asphalt additive according to claim 8, wherein the viscosity reducing agent is mixed in an amount of 10˜100 parts by weight with respect to 100 parts of the dregs of oil and fat.

10. The method for preparing a warm mix recycled asphalt additive according to claim 7, wherein the fatty acids are one or more selected from the group consisting of stearic acids, lauric acids, palmitic acids, myristic acids, oleic acids, linoleic acids, linolenic acids and ricinoleic acids.

11. A warm mix recycled asphalt mixture comprising a warm mix recycled asphalt additive comprising 2 to 15 wt % of dregs of oil and fat which are by-products remaining after extraction of fatty acids from the oil and fat, based on the total amount of waste asphalt contained in waste asphalt concrete.

12. The warm mix recycled asphalt mixture according claim 11, wherein the oil and fat are one or more selected from the group consisting of vegetable oil and fat, animal oil and fat, and synthetic oil and fat.

13. The warm mix recycled asphalt mixture according claim 11, wherein the fatty acids are one or more selected from the group consisting of stearic acids, lauric acids, palmitic acids, myristic acids, oleic acids, linoleic acids, linolenic acids and ricinoleic acids.

14. The warm mix recycled asphalt mixture according claim 11, wherein the dregs of oil and fat have viscosity at temperature of 140° C. of 80 cps or less.

15. The warm mix recycled asphalt mixture according claim 11, wherein the warm mix recycled asphalt additive further comprises one or more viscosity reducing agent selected from the group consisting of surfactants, aromatic oils, paraffin oils, vegetable oils and animal oils.

16. The warm mix recycled asphalt mixture according claim 15, wherein the viscosity reducing agent is comprised in an amount of 10˜100 parts by weight with respect to 100 parts by weight of the dregs of oil and fat.

17. A method for preparing a warm mix recycled asphalt mixture comprising:
preparing a warm mix recycled asphalt additive comprising dregs of oil and fat which are by-products remaining after extraction of fatty acids from the oil and fat; and
melt-mixing the warm mix recycled additive with cyclic aggregate comprising waste asphalt concrete,
wherein the preparing the warm mix recycled asphalt additive comprises:
extracting the fatty acids from the oil and fat; and
obtaining dregs of oil and fat which are by-products remaining after extraction, and
wherein the warm mix recycled additive is comprised in an amount of 2 to 15 wt % based on the total amount of waste asphalt contained in the waste asphalt concrete.

18. The method for preparing a warm mix recycled asphalt mixture according to claim 17, wherein the fatty acids are one or more selected from the group consisting of stearic acids, lauric acids, palmitic acids, myristic acids, oleic acids, linoleic acids, linolenic acids and ricinoleic acids.

19. The method for preparing a warm mix recycled asphalt mixture according to claim 17, further comprising mixing the obtained dregs of oil and fat with one or more viscosity reducing agent selected from the group consisting of surfactants, aromatic oils, paraffin oils, vegetable oils and animal oils.

20. The method for preparing a warm mix recycled asphalt mixture according to claim 19, wherein the viscosity reducing agent is comprised in an amount of 10˜100 parts by weight with respect to 100 parts by weight of the dregs of oil and fat.
